(19) United States
(12) Patent Application Publication
(10) Pub. No.: US 2008/0075875 A1
(43) Pub. Date: Mar. 27, 2008

(54) Device for Pre-Heating a Carrier Fluid for Spray Painting

(75) Inventor: Ottavio Milli, Grosseto (IT)

Correspondence Address: PEARNE & GORDON LLP, 1801 EAST 9TH STREET, SUITE 1200, CLEVELAND, OH, 44114-3108, US

(73) Assignee: EUROSIDER S.A.S. DI MILLI OTTAVIO & C., Grosseto (IT)

(21) Appl. No.: 11/659,585

(22) PCT Filed: Aug. 8, 2005
(86) PCT No.: PCT/IB05/02376

§ 371 Date: Feb. 7, 2007

(30) Foreign Application Priority Data
Aug. 9, 2004 (IT) BO2004A000518

(51) Int. Cl. B05B 7/16; B05D 1/02; C01B 21/00

(52) U.S. Cl. 427/422; 118/302; 423/351

(57) ABSTRACT

A spray painting device comprising a heated tube (15) for pre-heating the carrier fluid for painting.

### TECHNICAL FIELD

The present invention relates to the sector for the production of a carrier fluid in spray painting systems (even of the powder type), and in particular the production of nitrogen from air using hollow fibre separation membranes.

### BACKGROUND ART

It is known that in the painting sector in general and in particular for spray painting, the paint is mixed with a carrier fluid normally consisting of compressed air, and that the drying times for the layers of paint applied are too long partly due to the humidity present in the painting environment and absorbed by the carrier fluid and by the components to be painted.

At present, drying times are reduced both by using hot dried air and other measures such as the use of volatile solvents.

In particular, the length of time needed for the paint to dry is a problem which affects water-based painting systems, increasingly used due to their low environmental impact and greater safety, but which at the same time, using water as a solvent, require longer drying times.

Moreover, it was found that in spray painting systems the problem of keeping the flow of carrier fluid at or bringing it to the required temperature at the moment of mixing with the paint has not yet been solved.

Therefore, the sector badly needs a device able to almost instantly (i.e.: within several seconds, for example 5-30 seconds after air infeed) supply the spray painting system with a flow of pressurised carrier fluid (for example dried air or nitrogen) which can drastically reduce the drying times for the paint applied.

### DISCLOSURE OF THE INVENTION

Therefore, another aim of the invention is to offer a painting system in which the temperature of the carrier fluid is kept at or brought to the required temperature at least at the moment of mixing.

Accordingly, a device, an apparatus and method for spray painting were provided as described in claims 1 to 9.

A first advantage is the reduction of the drying time from the current 15-40 minutes to times which may vary from one minute to 5 minutes with the system disclosed, particularly for spray painting with water-based paints.

Another advantage is the use of hot nitrogen, which may be produced with hollow fibre membranes (preferably) or with PSA (Pressure Swing Absorption) systems and which gives improved fluidification of the paint, allowing a reduction in the number of passes necessary and possible elimination of the water or solvents from the paint.

Yet another advantage is the possibility of passing a jet of hot nitrogen only over the surface to be painted before applying the paint, to remove dust and humidity, and after painting, to promote almost instant drying of the coating of paint.

An advantage of the painting method disclosed is that the nitrogen has an extremely low “dew point” (around −50° C.), meaning that the use of hot nitrogen removes all traces of humidity and accelerates drying of the paint or the surface struck by the flow.

Yet another advantage is that the hot fluid flowing out also heats the spray gun, normally made of aluminium, which in turn transmits the heat to the paint, heating it up and improving its behaviour.

According to another aspect of the invention, it is also known that air separation systems for the production of nitrogen which use hollow fibre membranes need hot air so that the fibre can achieve the optimum performance required for the quality and/or quantity of nitrogen produced.

It is also known that module efficiency will only actually be achieved when the air infeed temperature and external temperature conditions have stabilised along the entire length, giving maximum performance and optimum air consumption, considering that in general the optimum air infeed temperature may vary from 24° C. to 60° C. with pressures between 4 and 20 bar/G.

For this purpose, pre-heating systems are known, which allow treatment of the air destined for the membrane at a controlled temperature, and, to heat the outside of the membrane, heated cabinets in which the module can be placed, or heating cables arranged around the membrane modules.

However, the systems currently known are inefficient, expensive and are not very advantageous in technical terms.

On this subject it is important to consider that there are many membranes on sale with a length which may vary between 20 cm and approximately 2 m in which, during separation, the pre-heated air which passes through the membrane tends to cool as it moves away from the air inlet.

Consequently, particularly for “long” modules, the membrane fibres work in conditions increasingly distant from the optimum conditions, with a negative effect on overall system efficiency.

Another aim of the present invention is, therefore, to overcome the disadvantages of the known systems, by providing an apparatus and method for the production of nitrogen as described in claims 10 to 23.

The apparatus and method disclosed allow, in general, very efficient use of the hot air destined for the fibres, which at the same time is used to evenly heat the membrane from the outside and if necessary the nitrogen produced, to obtain a modified air flow rich in nitrogen that is very pure (from 78% to 99.99%) and at the required temperature.

Further advantageous aspects of the invention are described in the dependent claims and consist of geometric simplicity, compact dimensions and simple construction, which may be suitable for modular use.

### BRIEF DESCRIPTION OF THE DRAWINGS

The technical features of the present invention, in accordance with the above-mentioned aims, are set out in the claims herein and the advantages more clearly illustrated in the detailed description which follows, with reference to the accompanying drawings, which illustrate a preferred embodiment of the invention without limiting the scope of the inventive concept, and in which:

FIG. 1 is a view of a first embodiment of the invention, with some parts cut away to better illustrate internal details;

FIG. 2 is a view of a carrier fluid feed tube in accordance with the present invention for spray painting systems.

### DETAILED DESCRIPTION OF THE PREFERRED EMBODIMENTS OF THE INVENTION

FIG. 2 illustrates a nitrogen feed tube 15 connected at a first end 30 to the container 1 and at a second end 31 to a spray painting gun 27, in the case of application of the machine in a spray painting system.

Advantageously, in particular for painting with water-based paints, the use of hot nitrogen accelerates paint drying times.

Moreover, the flow of hot nitrogen alone can also be directed at the surface to be painted, to completely dehumidify it and, after painting, it can be directed onto the coating of paint just sprayed, to further accelerate its drying before a second pass, if needed.

According to the invention, the tube 15 can also be fitted with a heating element 16 located at least on part of its length, to maintain the nitrogen temperature until the moment of spraying, which in some cases may occur many metres from the machine.

The element 16 preferably consists of a resistor inside the tube 15, in direct contact with the flow of nitrogen, and connected to a thermoregulator 14 by contacts 32, which control the heating of the coil according to the temperature values reached and detected by a thermocouple located at the outlet for fluid from the gun or airbrush.

The same signal may advantageously be used to enable or disable dispensing of the pressurised carrier fluid.

However, it should be understood that different heating elements may be used, located inside or outside the tube 15.

Moreover, it is important to emphasise that use of the heated tube 15, although particularly useful in combination with a hot nitrogen painting system, may advantageously be applied in conventional spray painting systems which use compressed air as the paint carrier (treated differently for heating and/or drying), in order to heat the carrier fluid and therefore improve paint drying.

With reference to the accompanying drawings, according to another aspect of the invention, it comprises a box-shaped container 1, which in the embodiment described is of the “stand alone” type, but which may also be mounted horizontally on a wall or on air compressors.

The container 1 delimits a hot chamber 17 containing heating elements, for example one or more flat resistors 2a arranged laterally or on top of one another.

A separation membrane 18 may be inserted in the hot chamber 17, to produce nitrogen (or modified air rich in nitrogen), communicating with the outside of the container through an air inlet 19 and an outlet 11 for the nitrogen produced.

The pipe 20 which feeds the air from the inlet 19 to the membrane 18 is preferably fitted with combined filters 12 for eliminating any impurities in the air such as oil, particulate and other elements.

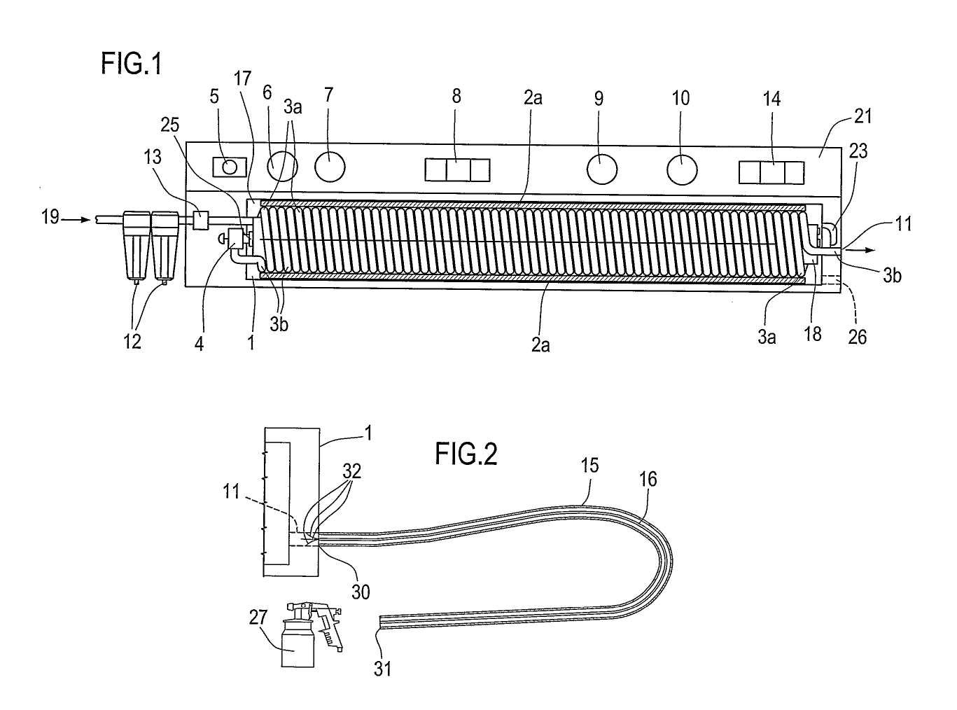

With reference to FIG. 1, according to the invention the air infeed pipe continues inside the chamber 17 in a spiral or coil 3a around the membrane 18, until it connects to the point 23 at which air enters the membrane 18.

In the embodiment described, the coil 3a consists of a copper tube, but it may be made of aluminium or another material suitable for transmitting heat to the air fed in.

From the intake point, the compressed air passes through the membrane, being separated into a component rich in nitrogen which arrives at a membrane outlet 25, and a permeate gas which can be removed through a container bleeder hole 26, directly or after being taken into the chamber 17 again.

From the membrane outlet 25 the nitrogen, preferably after passing through a flow regulator, for example of the BPR (Back Pressure Regulator) type, goes through a second coil 3b, also wound around the membrane 18, which carries the nitrogen to the outlet 11 for use by the user device.

The device also comprises a set of sensors and controls connected to a panel 21 which may be installed directly on the container 1.

In the embodiment described, the set of sensors connected to the panel 21 comprises: an ON/OFF switch 5, an air infeed pressure gauge 6, a nitrogen outfeed pressure gauge 7, a thermoregulator or thermostat 8 for the temperature of the hot chamber 17, a pressure regulator 9 for the nitrogen fed out destined for painting, a pressure gauge 10 for the nitrogen fed out for painting operations, an air infeed pressure regulator 13, preferably between the values of 3 and 15 bar.

In operation, when the machine is switched on it takes just a few seconds for the resistors 2a to bring the hot chamber 17, and so also the membrane 18 and the coils 3a, 3b, to an operating temperature, which the thermostat 8 can keep at a value between 20° C. and 100° C., preferably 50°.

The compressed air from the inlet 19 then passes through the coil 3a, which heats up the air, and arrives at the point 23 where it enters the membrane at an optimum temperature for the separation process.

Moreover, at the same time the chamber 17 heats the membrane 18, optimising performance.

According to the invention, the nitrogen produced in this way, already suitable for many applications may be further heated by passing through the coil 3b to compensate for the drop in temperature which occurs during the air separation process in the membrane.

Therefore, at the outlet 11 hot nitrogen is available, of the predetermined quality and at the predetermined temperature, preferably with an instantaneous production rate of between 1 Nm³/h and 1000 Nm³/h.

If additional nitrogen production is required or not using entirely the coil 3b, it is also possible to use a heater that is separate from the device, able to heat the nitrogen to the operating temperatures required in each case (which may be different to the temperature of the hot chamber 17) and most suitable for the particular painting conditions.

From the above description it is evident that the device disclosed provides the advantage of heating in a single environment, the hot chamber 17, both the membrane and the air heating coil 3a and, if present, the nitrogen heating coil 3b. Thus, without inserting additional heaters, this provides the triple advantage of heating both the membrane and the air to be separated (promoting immediate greater membrane efficiency at the preset temperature, pressure and purity values) and heating the nitrogen produced, for use for example as a carrier fluid for spray painting.

The invention may have evident industrial applications. It can be subject to modifications and variations without thereby departing from the scope of the inventive concept and all the details of the invention may be substituted by technically equivalent elements.

1. A spray painting device, comprising a tube (15) with a first connection (30) to a supply of pressurised carrier fluid and a second connection (31) to a spray painting gun (27), characterised in that it is fitted with heating means (16) located along at least a portion of its length.

2. The device according to claim 1, characterised in that the heating means are located inside the tube, in contact with the carrier fluid.

3. The device according to claim 1, characterised in that the heating means are located outside the tube.

4. A spray painting apparatus comprising a supply of carrier fluid, a spray gun for a paint/fluid mixture and a connecting tube according claim 1.

5. The apparatus according to claim 4, comprising means (14) for regulating the temperature of the fluid according to the temperature values detected by a thermocouple located at the outlet for fluid from the gun or airbrush.

6. The apparatus according to claim 4, characterised in that detection of the fluid temperature values is used to enable or disable the supply of pressurised carrier fluid.

7. Use of a tube according to claim 1 for transporting a pressurised carrier fluid for spray painting, from a carrier fluid supply to a spray painting gun (27).

8. A spray painting method comprising a step of spraying a mixture of a flow of hot carrier fluid and paint on a surface to be painted, in which the flow of carrier fluid is kept at a required temperature at least at the moment of mixing with the paint.

9. The method according to claim 8, in which the carrier fluid is nitrogen or modified air rich in nitrogen with purity from 78% to 99.99%.

10. A device for the production of nitrogen from compressed air using separation membranes (18), comprising a hot chamber (17) housing at least one membrane (18) and means for pre-heating the compressed air destined for the membrane, characterised in that the compressed air pre-heating means comprise a pipe (3a) which feeds the air to the membrane (18) located inside the hot chamber (17), the pipe being made of a heat conducting material so that the compressed air can be heated up.

11. The device according to claim 10, characterised in that the air feed pipe is in the form of a metal spiral (3a) wound around the membrane (18).

12. The device according to claim 10, characterised in that the hot chamber (17) has one or more heating elements (2a) located inside the chamber.

13. The device according to claim 10, comprising a heater outside the chamber (17) able to heat the nitrogen produced to different operating temperatures.

14. The device according to claim 10, comprising a pipe (3b) which feeds the nitrogen produced by the membrane to an outlet (11), the pipe being located inside the hot chamber (17) and made of a heat conducting material so that the nitrogen can be heated up.

15. The device according to claim 14, characterised in that the nitrogen feed pipe is in the form of a metal spiral (3b) wound around the membrane (18).

16. A spray painting apparatus comprising a device for the production of nitrogen according to claim 10, and a spray painting gun (27) fed by the device.

17. The apparatus according to claim 16, comprising a tube (15) communicating with the nitrogen outlet (11) from the hot chamber (17) and with the gun (27), the tube (15) being fitted with heating elements (16) along at least part of its length.

18. A method for the production of nitrogen using separation membranes (18), comprising the steps of feeding compressed air using a feed pipe (3a) to at least one membrane, and positioning the membrane (18) and the pipe (3a) inside a hot chamber (17).

19. The method according to claim 18, in which there is a pipe (3b) which feeds the nitrogen produced by the membrane to the outlet, the pipe being located inside the hot chamber (17).

20. A spray painting method, comprising a step of spraying a mixture of a flow of hot nitrogen and paint on a surface to be painted.

21. The spray painting method according to claim 20, comprising a preliminary step of dehumidifying the surface to be painted by spraying the surface with a flow of hot nitrogen.

22. The spray painting method according to claim 20, comprising a final step of drying the painted surface by spraying it with a flow of hot nitrogen.

23. The method according to claim 20, in which the paint is a water-based paint.
